(19) United States
(12) Patent Application Publication
(10) Pub. No.: US 2002/0145723 A1
(43) Pub. Date: Oct. 10, 2002

(54) Technique for lowering the noise/signal ratio of a range finder

(75) Inventor: Kao Po-Sung, Taichung (TW)

Correspondence Address: BROWDY AND NEIMARK, P.L.L.C., 624 Ninth Street, N.W., Washington, DC, 20001, US

(73) Assignee: ASIA OPTICAL CO., LTD., Taichung Export Processing Zone (TW)

(21) Appl. No.: 10/055,018

(22) Filed: Jan. 25, 2002

Related U.S. Application Data
(63) Continuation-in-part of application No. 09/495,943, filed on Feb. 2, 2000, now abandoned.

(30) Foreign Application Priority Data
Sep. 7, 1999 (TW) 88115362

(51) Int. Cl. G01C 3/08

(52) U.S. Cl. 356/4.01

(57) ABSTRACT

Laser range finder capable of lowering the noise/signal ratio of received laser radiation, composed of: a telescope; a laser transmitter; a transmission system; a receiving system; and a laser sensor, wherein the receiving area of the laser sensor is larger than the laser transmitter, and the focal length of the receiving system is longer than that of the transmission system, so that the image of the laser transmitter formed on the laser receiver is larger than the laser transmitter.

This is a continuation-in-part of application Ser. No. 09/495,943, filed Feb. 2, 2000, the entirety of which is incorporated herein by reference.

### BACKGROUND OF THE INVENTION

The present invention relates to a technique to reduce the optical noise/signal ratio, and more particularly to a technique applied to a range finder to reduce the noise/signal ratio for improved signal reception.

Conventional range finders, especially laser range finders, have been widely used to measure the distance of a remote object or target. With laser range finders, for example, the basic measuring method is such that a laser pulse beam is transmitted toward a target and simultaneously a photosensor starts to receive laser radiation reflected from the target. Then the time of transmission of the laser pulse beam and the time of reception of the reflected laser radiation are compared to obtain a time difference. The time difference (Δt) is multiplied by light speed (c) and divided by 2 so as to calculate the distance (Δd) between the laser range finder and the target according to the equation:

Δd=Δt×c/2

In general, the laser range finder includes a laser transmitter for transmitting the laser pulse beam and a photosensor for receiving the reflected laser radiation. The transmitter includes a transmission system that includes a transmission lens unit for converging the laser pulse beam from the laser transmitter to form a parallel, or collimated, laser pulse beam that is directed outwards toward the target. The output surface of the laser transmitter is placed at the focal point of the transmission lens unit to collimate the laser beam so as to achieve better aiming and less scattering. The laser range finder further includes a receiving lens unit for concentrating the reflected laser at a focal point, or area, thereof. The photosensor is positioned at the focal point, ot area, of the receiving lens unit for receiving the reflected laser radiation.

Accordingly, a transmission/receiving system is established.

Conventionally, in order to reduce manufacturing costs, generally the same lens will be used as the transmission lens and the receiving lens. Therefore, the image formed on the photosensor will have a dimension equal to that of the light emitting area of the laser transmitter. However, the area of the photosensor is generally larger than the light emitting area of the laser transmitter so that the laser transmitter image projected onto the photosensor often only occupies a small part of the entire photosensor area. As shown in FIG. 1, the photosensing region 11 of the photosensor includes a receiving section, or system, 12 on which the laser radiation image (shown by a shaded pattern) is formed. The remaining part of the photosensing region is a non-receiving section 13. With respect to a laser range finder, the signal analysis process only requires the laser beam signal, so that all of the signals obtained from the non-receiving section 13 are noise. Since, in conventional systems the area of the photosensing region 11 of the photosensor is larger than the light emitting area of the laser transmitter, the ratio of the receiving section 12 to the non-receiving section 13 is small. In other words, the noise/signal ratio will be relatively high. This will add to the difficulty in processing range finder signals and reduce the capabilities of the range finder.

### BRIEF SUMMARY OF THE INVENTION

It is therefore a primary object of the present invention to provide a technique for reducing the noise/signal ratio of a range finder.

It is a further object of the present invention to provide a technique using telephoto lenses to reduce the noise/signal ratio of the range finder.

To achieve the above objects, the present invention provides a range finder that magnifies the image of the laser transmitter on the photosensor for enlarging the ratio of the receiving section to the non-receiving section so as to lower the noise/signal ratio.

### BRIEF DESCRIPTION OF THE DRAWING

FIG. 1 is a pictorial view of the photosensing region of a photosensor according to the prior art.

FIG. 2 is a view similar to that of FIG. 1 of the photosensing region of a photosensor according to the present invention.

FIG. 3 is a cross-sectional view of one embodiment of a laser range finder according to the invention.

FIG. 4 is a diagram showing one optical beam path in the range finder of FIG. 3.

FIG. 5 is a diagram showing a second optical beam path in the range finder of FIG. 3.

FIG. 6 is a view similar to that of FIG. 4 of a second embodiment of a laser range finder according to the invention.

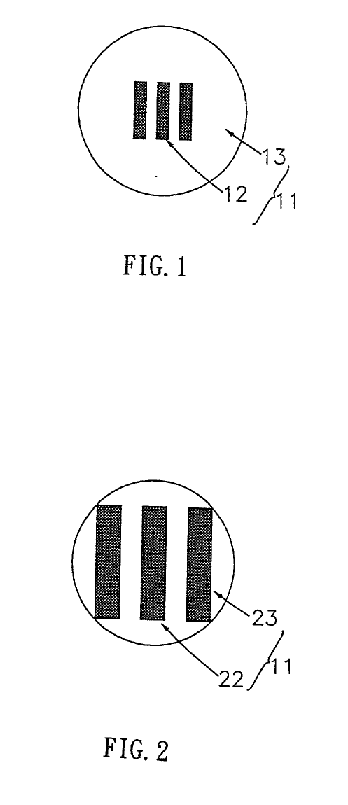

### DETAILED DESCRIPTION OF THE INVENTION

FIG. 2 shows the case that the laser radiation image on the photosensor is magnified so that in the photosensitive region 11 of the photosensor, the magnified receiving section 22 will occupy an area larger than the receiving section 12 of the prior art. Reversely, the non-receiving section 23 will be reduced compared to non-receiving section 13 of the prior art. Therefore, through the change as shown in FIG. 2, the ratio of the receiving section to the non-receiving section will be enlarged. In other words, the noise/signal ratio is lowered.

If the focal length of the transmission lens unit is F1, the diameter of the light emitting area of the laser transmitter is D1, the focal length of the receiving lens unit is F2 and the diameter of the received image is D2, the relationship therebetween can be expressed as follows:

F1/F2=D1/D2, or

D2=F2/F1×D1.

Therefore, in the case that the effective focal length of the receiving leveling lens unit is increased, the laser radiation image on the photosensitive region 11 of the photosensor can be magnified to lower the noise/signal ratio as aforesaid.

In general, in order for the focal length to be increased, the length of the laser range finder must be increased for receiving the lens unit. However, in order to reduce the volume of the laser range finder, the present invention further employs an assembly of a concave lens and a convex lens to reduce the necessary length.

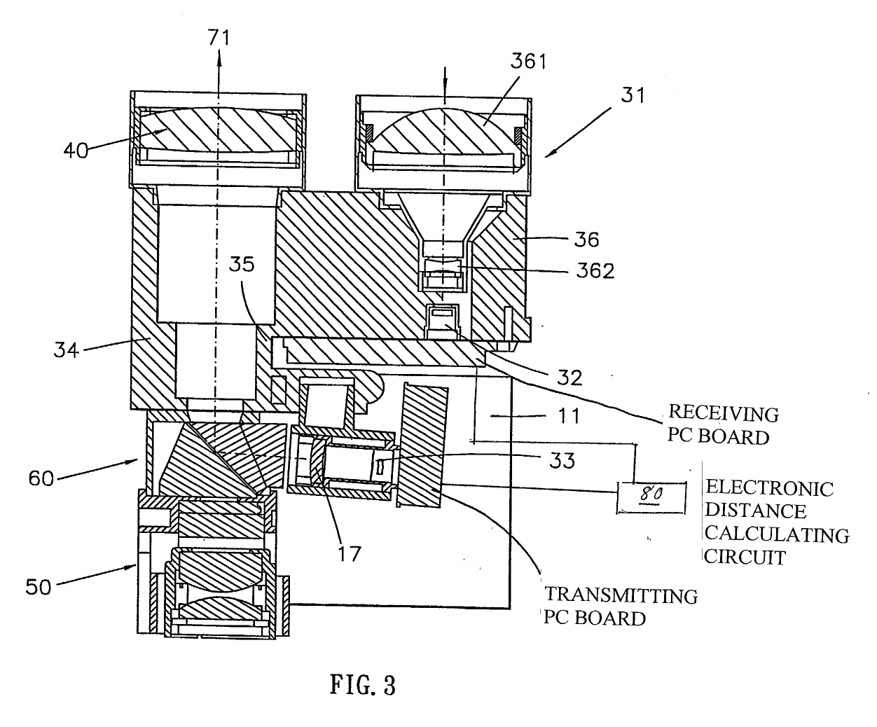

FIG. 3 shows a first embodiment of a range finder 31 according to the invention that includes a receiving unit, or system, 36 composed of laser radiation sensor 32 having the photosensitive surface 11, a non-spherical convex lens 361 and a concave lens 362 for forming a magnified image of the laser transmitter beam on surface 11 and a receiving PC board connected to receive image signals from sensor 32.

A laser transmitting unit, or system, 35 includes a laser transmitter 33 driven by circuitry on a transmitting PC board to produce pulses of a laser beam (or other usable invisible light beam with suitable wavelength) and a lens system composed of an objective lens 40 and an auxiliary lens 17 for directing light from transmitter 33 in the form of a beam along an axis 71 toward a target.

The laser beam reaches the surface of the target and a portion of the laser beam radiation is reflected back to the range finder. The laser radiation sensor 32 receives the reflected laser radiation and produces electrical signals that are supplied to circuitry on the receiving PC board.

Both the transmitting PC board and the receiving PC board are connected to a programmed electronic circuit 80 that is constructed and programmed according to techniques already known in the art to calculate the distance between the target and the laser range finder based on the times of emission of each laser pulse and of reception of radiation reflected from the target.

Range finder 31 further includes a telescope 34 that includes an objective lens assembly 50 through which a user can view the target, the optical axis of the telescope being coincident with axis 71. This allows the user to easily aim the range finder at the target. In addition, it reduces the manufacturing cost and size of the range finder.

The range finder further includes a prism 60 that is constructed to deflect laser radiation from transmitter 33 onto optical axis 71, while allowing visible light to travel to objective lens assembly 50 along axis 70. Prism unit 60 may be constructed in the manner disclosed in copending U.S. application Ser. No. 09/500,227, filed on Feb. 8, 2000, the contents of which are incorporated herein by reference.

The optical path of one embodiment of receiving unit, or system, 36 is shown in FIG. 4. In order to save space, a telephoto lens design is employed. In this optical design, the light beam is first converged by the convex lens 361 and then diverged by the concave lens 362 and focused onto the photosensitive surface 11 of sensor 32. This optical design is able to make the effective focal length of the receiving unit, or system, longer than the actual assembly length. Accordingly, it is equivalent to a convex lens with a focal length equal to the effective focal length, while only a shorter space is required. Therefore, the assembly space is reduced. In the example shown in FIG. 4 the effective focal length is 110 mm and the actual assembly length is 45 mm. Thus, focal length/assembly length=2.44.

It can be known from the calculation formula of complex lenses:

1/f=1/fl+1/f2−d/flf2,

where f is the complex focal length of the complex lenses,

f1 is the focal length of a lens A,

f2 is the focal length of the other lens B, and

d is the distance between lenses A and B.

that the shorter the focal length of the convex lens 361, the better the effect is. Therefore, in this embodiment, a non-spherical convex lens 361, as illustrated in FIG. 3, can be employed so as to further reduce the space required and enhance resolution.

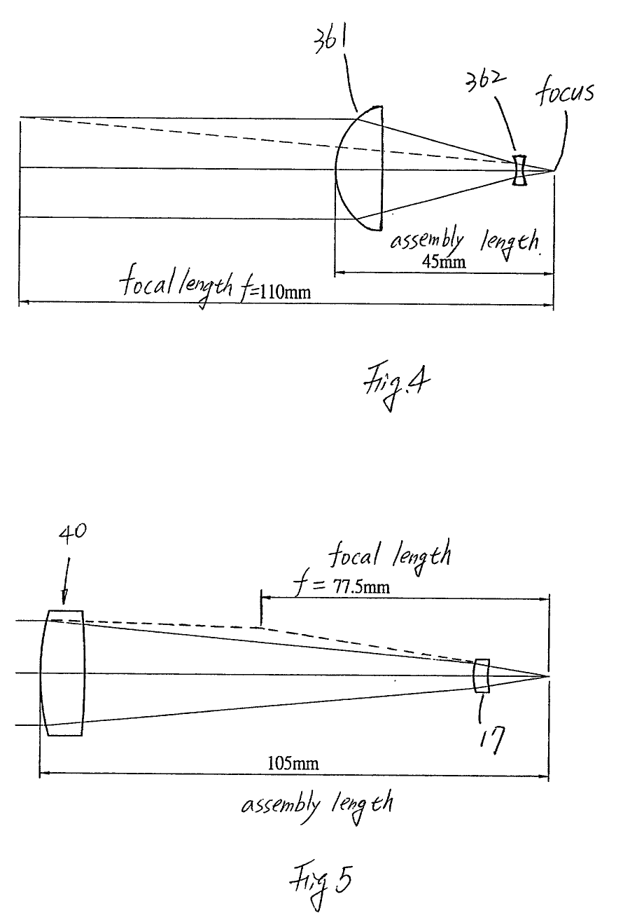

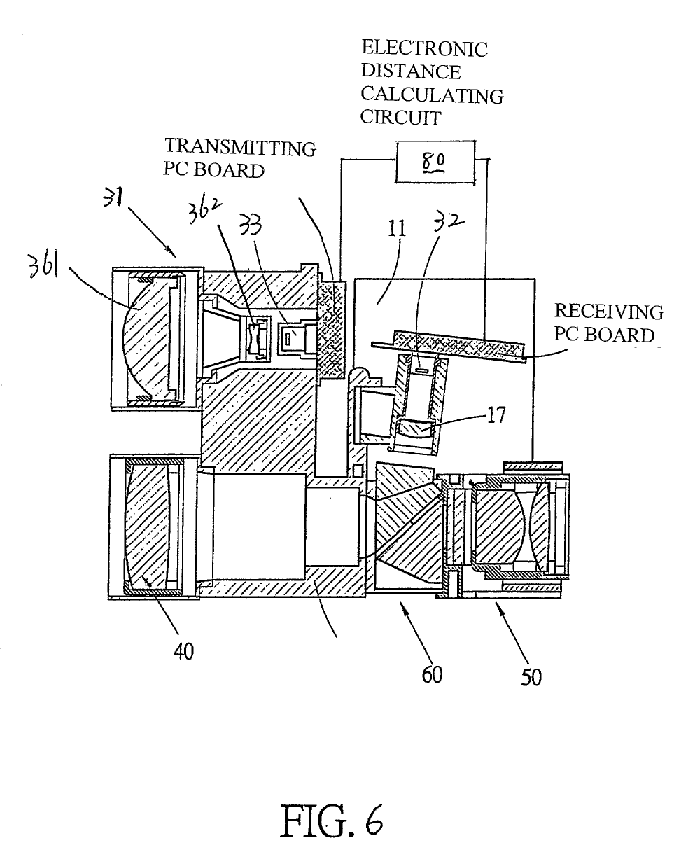

The optical path of one embodiment of transmitting unit, or system, 35 is shown in FIG. 5 and includes the concave objective lens 40 and the auxiliary lens 17, here a concavo-convex lens, that shortens the focal length of the transmitting unit, or system. In the example shown in FIG. 5 the effective focal length is 77.5 mm and the actual assembly length is 105 mm. Auxiliary lens 17 shortens the focal length of the transmission unit, or system, and corrects transmission aberrations.

With the dimensions shown in FIGS. 4 and 5, the image of the laser source is magnified by 1.42 on the photosensitive surface 11 of sensor 32. As a result, both noise and range finder dimensions are reduced.

According to a preferred embodiment of the invention, photosensitive surface 11 of sensor 32 has a diameter of 0.5 mm and the image formed thereon has a width of 0.464 mm, thus substantially filling the area of surface 11.

FIG. 6 shows a second embodiment of a range finder 31 according to the invention in which the transmitting and receiving units, or systems, are interchanged. Correspondingly, the curvatures of lenses 17, 40, 361 and 362 will be modified to make the focal length of the receiving unit, or system, longer than that of the transmitting unit, or system.

The above embodiments serve only to illustrate the present invention, and are not intended to limit the scope thereof. Many modifications of the above embodiments can be made without departing from the spirit of the present invention.

What is claimed is:

1. Method for lowering the noise/signal ratio of a range finder, the focal length of a receiving lens unit being longer than the focal length of a transmission lens unit, whereby the image of the laser transmitter formed on the photosensor is magnified and the area of the signal receiving section of the photosensor is larger than the focus of the receiving lens unit and smaller than or equal to the focus of the transmission lens unit to thereby lower the noise/signal ratio.

2. Method as claimed in claim 1, wherein the receiving lens unit includes a convex lens and a concave lens.

3. Method as claimed in claim 2, wherein the convex lens is a non-spherical convex lens.

4. Laser range finder capable of lowering the noise/signal ratio of received laser radiation, comprising: a telescope; a laser transmitter; a transmission system for transmitting a beam of radiation produced by said transmitter toward a target; a receiving system for receiving laser radiation reflected from the target; a laser sensor for sensing laser radiation received by said receiving system, and a range calculating system coupled to said laser transmitter and said laser sensor for calculating the distance between the target and the laser range finder, wherein the receiving area of the laser sensor is larger than the laser transmitter, and the focal length of the receiving system is longer than that of the transmission system, so that the image of the laser transmitter formed on the laser receiver is larger than the laser transmitter and the area of the signal receiving section of the laser sensor is larger than the focus of the receiving lens unit and smaller than or equal to the focus of the transmission lens unit.

5. A laser range finder comprising:
a transmission system for transmitting a beam of laser radiation along a transmission axis toward a target;
a receiving system for receiving laser radiation reflected from the target along a receiving axis;
a telescope unit having a viewing optical axis;
a prism; and
a range calculating system coupled to said transmission and receiving systems for calculating the distance between the target and the laser range finder wherein:
said receiving axis is laterally offset from said transmission axis and said viewing optical axis has at least a portion that is coincident with one of said transmission and receiving axes.

6. The laser range finder of claim 5 wherein:
said receiving system comprises a laser sensor and a receiving lens unit for directing laser radiation received by said receiving system onto said laser sensor, said receiving lens unit having a first focal length;
said transmission system comprises a laser transmitter and a transmission lens unit for forming the beam of radiation from laser radiation produced by said transmitter, said transmission lens unit having a second focal length; and
the first focal length is longer than the second focal length,
whereby the image of the laser transmitter formed on the photosensor is magnified and the area of the signal receiving section of the photosensor is larger than the focus of the receiving lens unit and smaller than or equal to the focus of the transmission lens unit to thereby lower the noise/signal ratio.

7. The range finder of claim 6 wherein said receiving lens unit has a physical length that is shorter than the first focal length.

8. The range finder of claim 6 wherein said transmission lens unit has a physical length that is longer than the second focal length.
